(19) United States
(12) Patent Application Publication
(10) Pub. No.: US 2014/0341444 A1
(43) Pub. Date: Nov. 20, 2014

(54) Systems and Methods for User Login

(71) Applicant: Tencent Technology (Shenzhen) Company Limited, Shenzhen (CN)

(72) Inventors: Jie Hou, Shenzhen (CN); Pengfei Xiong, Shenzhen (CN); Yan Liu, Shenzhen (CN); Hailong Liu, Shenzhen (CN); Bo Chen, Shenzhen (CN)

(73) Assignee: Tencent Technology (Shenzhen) Company Limited, Shenzhen (CN)

(21) Appl. No.: 14/219,403

(22) Filed: Mar. 19, 2014

Related U.S. Application Data
(63) Continuation of application No. PCT/CN2013/084938, filed on Oct. 10, 2013.

(30) Foreign Application Priority Data
May 14, 2013 (CN) 201310177304.0

(51) Int. Cl. G06K 9/00; G06K 9/62

(52) U.S. Cl. CPC G06K 9/00288; G06K 9/6202
USPC 382/118

(57) ABSTRACT

Systems and methods are provided for user login. For example, a login request from a first user is received, the login request being associated with fast login based on at least information associated with facial authentication; one or more first facial images of the first user are acquired; one or more first facial features are extracted from the one or more first facial images; the first facial features are compared with a predetermined feature template; and in response to a comparison result associated with the first facial features and the predetermined feature template exceeding a predetermined threshold, the first user is allowed to log in based on predetermined first user information of the first user.

### CROSS-REFERENCES TO RELATED APPLICATIONS

This application claims priority to Chinese Patent Application No. 201310177304.0, filed May 14, 2013, incorporated by reference herein for all purposes.

### FIELD OF THE INVENTION

Certain embodiments of the present invention are directed to computer technology. More particularly, some embodiments of the invention provide systems and methods for safety verification technology. Merely by way of example, some embodiments of the invention have been applied to user login. But it would be recognized that the invention has a much broader range of applicability.

### BACKGROUND OF THE INVENTION

Services provided for specific users become increasingly common when technologies become more user-oriented. To ensure the quality and security of user services, it is often necessary for a user to perform login operations, including entering an account name and a password that may be authenticated by a server to confirm the user's identity.

A password-memorization function is often provided so that the user does not need to frequently enter passwords in a trusted environment (e.g., the user's personal computer). For example, the user may voluntarily set whether the password should be memorized. If the password is set to be memorized, the login process is automatically performed upon next use so that the password-input operation is omitted.

The above-noted conventional approach has some problems. For example, once the password-memorization function is enabled for an application on a device, anyone who uses the device has an authorization to use. Under such circumstances, anyone who has access to the device can access all information of the application. As an example, if User B has access to User A's device, User B can access all information of the application for which User A enables the password-memorization function. Though it is convenient to log in using the password-memorization function, the security is reduced. In addition, the password-memorization function can be enabled or disabled without any other options. If the user prefers security and disables the password-memorization function, the user cannot enjoy the convenience of an easy login. On the other hand, if the user prefers a convenient login, the security of information cannot be guaranteed. With the development of the Internet and computer technologies, software-usage scenarios have become increasingly complicated. Under many circumstances, a 0-or-1 selection often cannot satisfy a user's more detailed needs for security, and the user may need more security options. Usually, a software including the conventional password-memorization function may not satisfy the user's needs for security. The user may be inclined to disable the password-memorization function, which reduces the usage of this function so that the convenience of an easy login is sacrificed for security.

Hence it is highly desirable to improve the techniques for user login.

### BRIEF SUMMARY OF THE INVENTION

According to one embodiment, a method is provided for user login. For example, a login request from a first user is received, the login request being associated with fast login based on at least information associated with facial authentication; one or more first facial images of the first user are acquired; one or more first facial features are extracted from the one or more first facial images; the first facial features are compared with a predetermined feature template; and in response to a comparison result associated with the first facial features and the predetermined feature template exceeding a predetermined threshold, the first user is allowed to log in based on predetermined first user information of the first user.

According to another embodiment, a device for user login includes a facial-image-acquisition module, a facial-feature-comparison module, and a login module. The facial-image-acquisition module is configured to, upon receipt of a login request from a first user, acquire one or more first facial images of the first user, the login request being associated with fast login based on at least information associated with facial authentication. The facial-feature-comparison module is configured to extract one or more first facial features from the one or more first facial images and compare the first facial features with a predetermined feature template. The login module is configured to, in response to a comparison result associated with the first facial features and the predetermined feature template exceeding a predetermined threshold, allow the first user to log in based on predetermined first user information of the first user.

According to yet another embodiment, a system for user login includes one or more data processors, and a computer-readable storage medium encoded with instructions for commanding the data processors to execute certain operations. For example, a login request from a first user is received, the login request being associated with fast login based on at least information associated with facial authentication; one or more first facial images of the first user are acquired; one or more first facial features are extracted from the one or more first facial images; the first facial features are compared with a predetermined feature template; and in response to a comparison result associated with the first facial features and the predetermined feature template exceeding a predetermined threshold, the first user is allowed to log in based on predetermined first user information of the first user.

According to yet another embodiment, a non-transitory computer readable storage medium comprises programming instructions for user login. The programming instructions are configured to cause one or more data processors to execute certain operations. For example, a login request from a first user is received, the login request being associated with fast login based on at least information associated with facial authentication; one or more first facial images of the first user are acquired; one or more first facial features are extracted from the one or more first facial images; the first facial features are compared with a predetermined feature template; and in response to a comparison result associated with the first facial features and the predetermined feature template exceeding a predetermined threshold, the first user is allowed to log in based on predetermined first user information of the first user.

For example, the systems and methods provided herein are configured to implement facial authentication in addition to a password-memorization function to improve security of login and retain the convenience of a fast login.

Depending upon embodiment, one or more benefits are achieved. These benefits and various additional objects, features and advantages of various embodiments of the present invention are fully appreciated with reference to the detailed description and accompanying drawings that follow.

### BRIEF DESCRIPTION OF THE DRAWINGS

FIG. 1 is a simplified diagram showing a method for user login according to one embodiment of the present invention;

FIG. 2 is a simplified diagram showing a method for user login according to another embodiment of the present invention;

FIG. 3 is a simplified diagram showing a method for user login according to yet another embodiment of the present invention;

FIG. 4 is a simplified diagram showing a device for user login according to one embodiment of the present invention; and

FIG. 5 is a simplified diagram showing a terminal for user login according to one embodiment of the present invention.

### DETAILED DESCRIPTION OF THE INVENTION

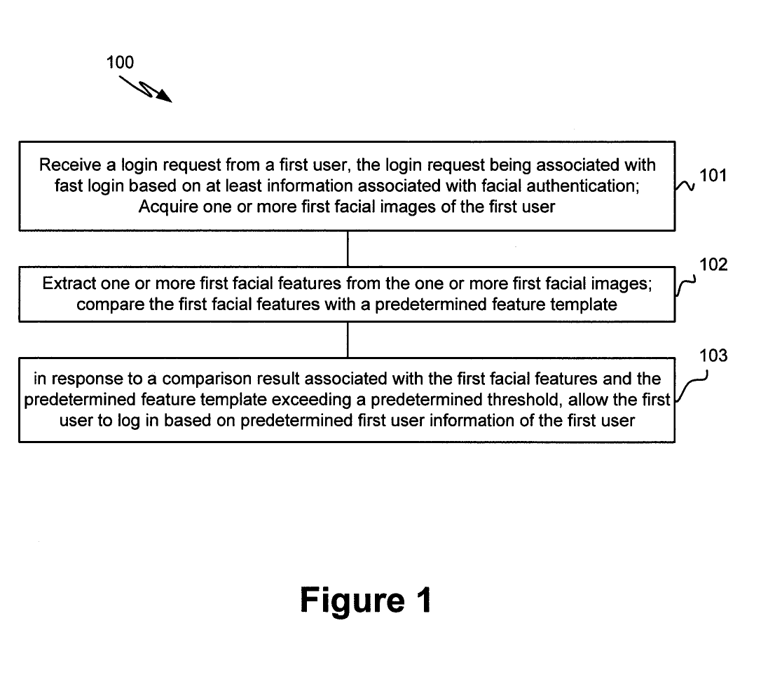

FIG. 1 is a simplified diagram showing a method for user login according to one embodiment of the present invention. This diagram is merely an example, which should not unduly limit the scope of the claims. One of ordinary skill in the art would recognize many variations, alternatives, and modifications. The method 100 includes at least the process 101 for receiving a login request from a first user and acquiring one or more first facial images of the first user, the process 102 for extracting one or more first facial features from the one or more first facial images and comparing the first facial features with a predetermined feature template, and the process 103 for allowing the first user to log in based on predetermined first user information of the first user in response to a comparison result associated with the first facial features and the predetermined feature template exceeding a predetermined threshold.

According to one embodiment, during the process 101, upon receipt of a login request from a first user, one or more first facial images of the first user are acquired. For example, the login request is associated with fast login based on at least information associated with facial authentication. In another example, the fast login corresponds to a login process based on pre-stored user information. That is, the fast login corresponds to a login process based on a password-memorization function. In some embodiments, the password-memorization function corresponds to a function provided by a software that requires login to memorize a correct password from a user so that the subsequent login processes are automated and the user does not need to enter the password again.

According to another embodiment, the user information includes a default account name and a user password, or includes only the user password corresponding to an account name entered by the user. For example, the content of the user information is related to the specific method for fast login. In some embodiments, the fast login is performed based on at least information associated with the default account name and the corresponding user password. That is, the user does not need to input the account name, and the login process is carried out based on the pre-stored account name and the pre-stored password (e.g., on a terminal). For example, the user information pre-stored on the terminal includes the account name and the user password. In certain embodiments, the fast login is performed based on the account name and user password which is automatically acquired in response to the account name provided by the user. That is, the user needs to input the account name. For example, the user information pre-stored on the terminal includes the user password and a mapping between the account name and the user password.

According to yet another embodiment, during the process 102, one or more first facial features are extracted from the one or more first facial images, and are compared with a predetermined feature template. For example, during the process 103, the first user is allowed to log in based on predetermined first user information of the first user, in response to a comparison result associated with the first facial features and the predetermined feature template exceeding a predetermined threshold.

In one embodiment, the acquiring one or more first facial images of the first user includes, acquiring a video clip of the first user, and acquiring the one or more first facial images from the video clip. For example, after the first facial features are extracted from the one or more first facial images and compared with the predetermined feature template, the login request is rejected in response to the comparison result associated with the first facial features and the predetermined feature template not exceeding the predetermined threshold.

In another embodiment, before the first facial features are extracted from the one or more first facial images and compared with the predetermined feature template, upon receipt of a registration request for registering facial features, one or more second facial images of a second user are acquired. For example, one or more second facial features from the second facial images of the second user. In another example, a predetermined feature template of the second user is generated based on at least information associated with the second facial features. In yet another example, a correspondence between the predetermined feature template of the second user and second user information of the second user is established.

In yet another embodiment, after the correspondence between the predetermined feature template of the second user and second user information of the second user is established, upon receipt of a cancellation request, the predetermined feature template of the second user and the correspondence between the predetermined feature template of the second user and the second user information of the second user are deleted. For example, the cancelling request is associated with cancelling fast login based on at least information associated with facial authentication.

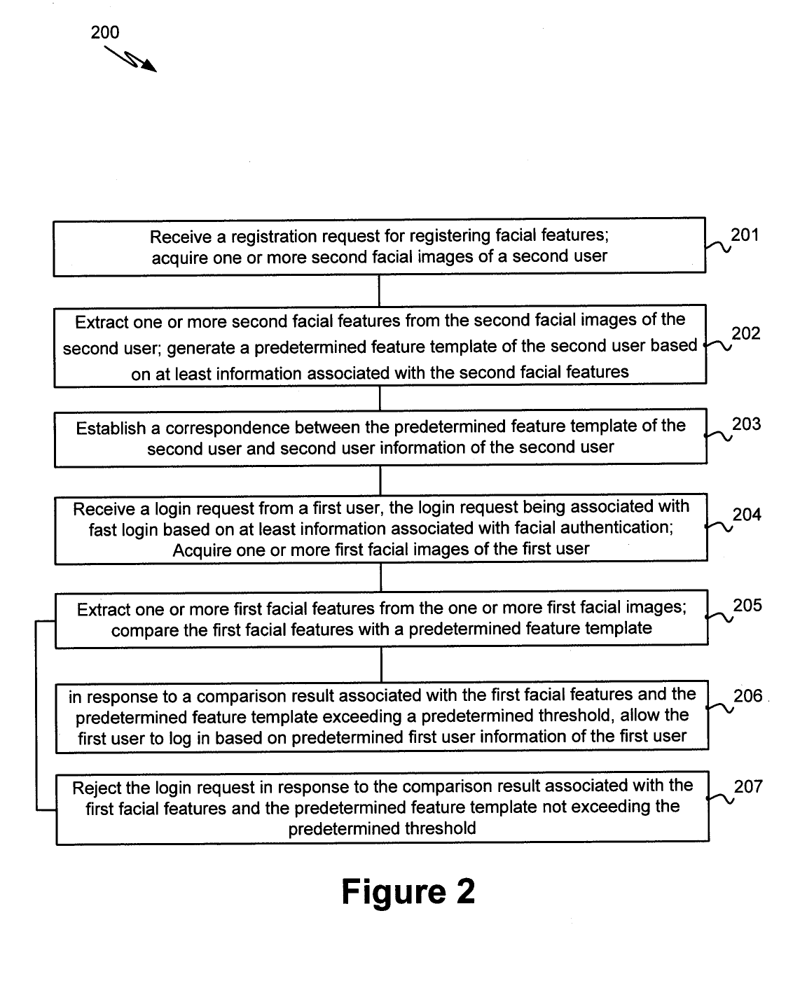

FIG. 2 is a simplified diagram showing a method for user login according to another embodiment of the present invention. This diagram is merely an example, which should not unduly limit the scope of the claims. One of ordinary skill in the art would recognize many variations, alternatives, and modifications. The method 200 includes at least the process 201 for receiving a registration request for registering facial features and acquiring one or more second facial images of a second user, the process 202 for extracting one or more second facial features from the second facial images of the second user and generating a predetermined feature template of the second user based on at least information associated with the second facial features, the process 203 for establishing a correspondence between the predetermined feature template of the second user and second user information of the second user, and the process 204 for receiving a login request from a first user and acquiring one or more first facial images of the first user. The method 200 further includes the process 205 for extracting one or more first facial features from the one or more first facial images and comparing the first facial features with a predetermined feature template, the process 206 for allowing the first user to log in based on predetermined first user information of the first user in response to a comparison result associated with the first facial features and the predetermined feature template exceeding a predetermined threshold, and the process 207 for rejecting the login request in response to the comparison result associated with the first facial features and the predetermined feature template not exceeding the predetermined threshold.

According to one embodiment, during the process 201, upon receipt of a registration request for registering facial features, the terminal acquires one or more second facial images of a second user. For example, the process 201 is performed when the second user has logged in. As an example, the terminal provides facial authentication service to the user when it has acquired the user information of the second user and allows login of the second user according to the user information. In another example, the terminal, upon receipt of the registration request, starts an image-acquisition device, such as a camera, to acquire one or more second facial images of the second user so as to establish (e.g., during the process 203) a correspondence between the second user information and a feature template of the second user determined according to the second facial images of the second user.

According to another embodiment, the process 201 is performed during the login process of the second user. For example, the terminal acquires the account name of the second user and provides the facial authentication service for the user. In another example, the terminal, upon receipt of the registration request, starts the image-acquisition device, such as a camera, to acquire the second facial images of the second user. In yet another example, upon the acquisition of the second facial images of the second user, the terminal prompts the second user to input an account password so as to establish a correspondence between the second user information and the predetermined feature template of the second user.

In some embodiments, the second facial images of the second user can be acquired using: (1) a camera of the terminal to take photos so as to acquire the second facial images of the second user; or (2) a camcorder of the terminal to take a video and acquire a video clip of the second user so as to acquire the second facial images from the video clip.

In certain embodiments, before the process 201, the method 200 further includes: enabling a password-memorization function based on facial authentication. For example, the terminal provides the password-memorization function based on facial authentication and the user can choose to enable or disable it. When the terminal detects that the user chooses to enable it, the terminal prompts the user to register the face of the user and executes the process 201 to complete the registration process, in some embodiments.

According to one embodiment, during the process 202, the terminal extracts one or more second facial features from the second facial images of the second user and generates a predetermined feature template of the second user based on at least information associated with the second facial features of the second user. For example, the extraction of the second facial features is performed on the one or more second facial images. If a single image is used for extraction, the facial features of the single image are extracted, and if multiple images are used, the facial features of each image are extracted, in some embodiments. For example, the extracted facial features are screened based on certain predetermined rules to acquire the one or more second facial features. As an example, the second facial features are from a single facial image of the second user, or from multiple facial images of the second user. Facial movements during acquisition of the facial images or resolution of the facial images may blur the facial images so as to cause inaccurate extraction of the facial features. Therefore, the extracted facial features are screened based on certain predetermined rules to determine certain facial features for generating the predetermined feature template so as to ensure the accuracy of facial features.

According to another embodiment, during the process 203, the terminal establishes the correspondence between the predetermined feature template of the second user and the second user information of the second user. For example, the registration request is associated with registration of human facial features.

In some embodiments, upon acquisition of the predetermined feature template, the terminal establishes the correspondence between the predetermined feature template of the second user and the second user information of the second user. For example, the correspondence is established locally on the terminal or on a server. In another example, if the correspondence is established locally on the terminal, facial authentication and subsequent fast login processes can take place on the terminal. On the other hand, if the correspondence is established on the server, the terminal acquires facial features of a user and sends the acquired facial features to the server. For example, the server performs the facial authentication and the subsequent fast login processes according to the facial features and the predetermined feature template.

In certain embodiments, after the correspondence between the predetermined feature template of the second user and the second user information of the second user is established, the method 200 further comprises: upon receipt of a cancellation request, deleting the predetermined feature template of the second user and the correspondence between the predetermined feature template of the second user and the second user information of the second user. For example, the cancellation request is associated with cancelling fast login based on facial authentication. As an example, the facial authentication of the second user performed before the fast login can be cancelled upon a user request. If the second user decides to request a cancellation by selecting the cancellation option, the terminal, upon receipt of the cancellation request, deletes the predetermined feature template of the second user and deletes the correspondence between the predetermined feature template of the second user and the second user information of the second user so as to eliminate the facial authentication process. Then, the second user may perform fast login based on the password-memorization function without facial authentication.

According to one embodiment, during the process 204, upon receipt of a login request from a first user, the terminal acquires one or more first facial images of the first user. For example, the login request is associated with fast login based on at least information associated with facial authentication. In another example, during the login process, a camera of the terminal is used to acquire the first facial images of the first user, or a camcorder of the terminal is used to acquire a video clip of the first user so as to acquire the first facial images from the video clip.

According to another embodiment, during the process 205, the terminal extracts one or more first facial features from the one or more first facial images, and compares the extracted first facial features with a predetermined feature template. For example, the login process is completed using one or more facial images based on a password-memorization function with facial authentication. Specifically, the extraction of facial features is performed on one or more facial images. For example, if a single facial image is used for extraction, the facial features of the single image are extracted; and if multiple facial images are used, the facial features of each facial image are extracted. In another example, the extracted facial images are then screened according to certain predetermined rules so as to acquire the first facial features. As an example, the first facial features are acquired from a single image or multiple images of the first user. Facial movements during acquisition of the facial images or resolution of the facial images may blur the facial images so as to cause inaccurate extraction of the facial features. Therefore, the extracted facial features are screened based on certain predetermined rules to determine certain facial features for generating the predetermined feature template so as to ensure the accuracy of facial features.

In some embodiments, the process 205 is performed on the server. For example, the terminal acquires the first facial images and uploads the first facial images onto the server so that the server can extract the first facial features from the first images and compare the first facial features with the predetermined feature template. The large amount of calculations required for such extraction and comparison are performed at the server so as to reduce the computation load on the terminal, in certain embodiments. For example, after the server determines a comparison result, the server returns the comparison result to the terminal. In another example, if the server determines the comparison result associated with the first facial features and the predetermined feature template exceeds the predetermined threshold, the server returns an instruction to allow the login request of the user to the terminal. In yet another example, when the server determines the comparison result associated with the first facial features and the predetermined feature template does not exceed the predetermined threshold, the server returns an instruction to reject the login request of the user to the terminal.

In one embodiment, during the process 206, the terminal allows the first user to log in based on the first user information of the first user in response to the comparison result associated with the first facial features and the predetermined feature template exceeding the predetermined threshold. For example, during the process 207, the terminal rejects the login request in response to the comparison result associated with the first facial features and the predetermined feature template not exceeding the predetermined threshold. As an example, if the comparison result associated with the first facial features and the predetermined feature template exceeds the predetermined threshold, the current user is deemed to be a same person as the user that implements the password-memorization function. Then, a fast login is allowed according to the pre-stored user information. On the other hand, if the comparison result is smaller than the predetermined threshold, the user is deemed to be a different person and the login request is rejected.

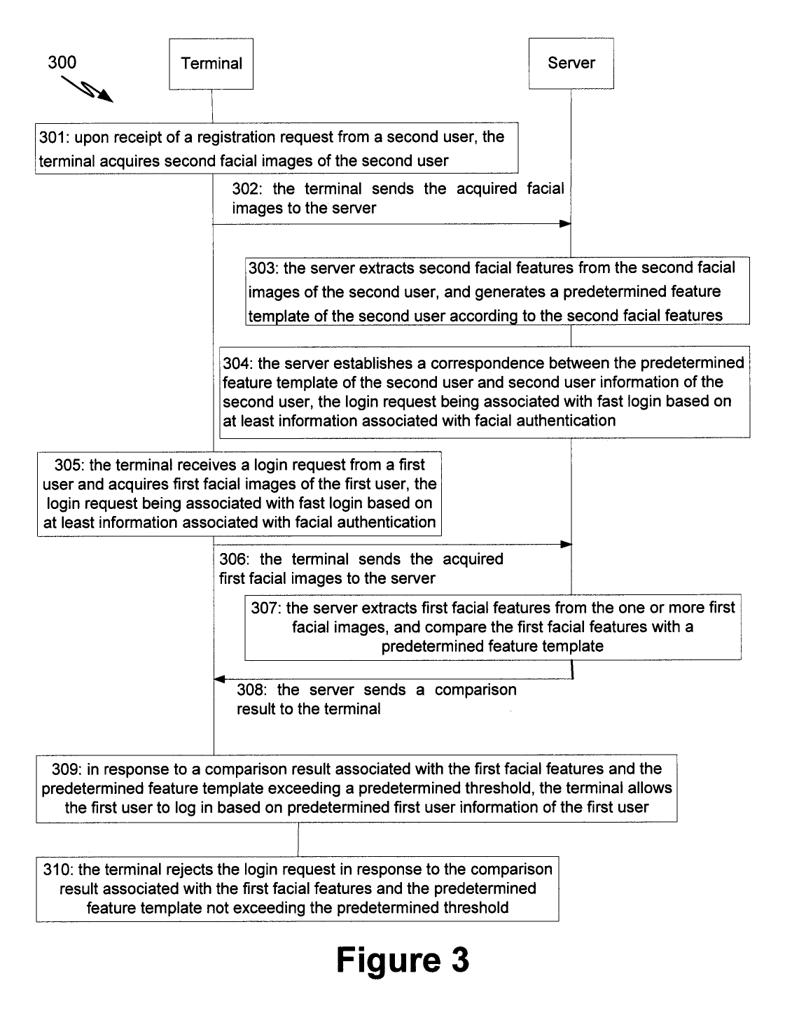

FIG. 3 is a simplified diagram showing a method for user login according to yet another embodiment of the present invention. This diagram is merely an example, which should not unduly limit the scope of the claims. One of ordinary skill in the art would recognize many variations, alternatives, and modifications. The method 300 includes at least the processes 301-310.

According to one embodiment, during the process 301, upon receipt of a registration request, a terminal acquires one or more second facial images of a second user. For example, during the process 302, the terminal sends the acquired second facial images to a server. In another example, during the process 303, the server extracts one or more second facial features from the second facial images of the second user and uses the second facial features of the second user as a predetermined feature template of the second user. In yet another example, during the process 304, the server establishes a correspondence between the predetermined feature template of the second user and second user information of the second user, where the registration request is used to request for registration of human facial features.

According to another embodiment, during the process 305, upon receipt of a login request of a first user, the terminal acquires one or more first facial images of the first user, where the login request is used to request for fast login based on facial authentication. For example, during the process 306, the terminal sends the first facial images of the first user to the server. In another example, during the process 307, the server extracts one or more first facial features from the first facial images and compares the first facial features with the predetermined feature template. In some embodiments, the extraction and comparison of facial features are performed by the server. In other embodiments, the extraction of facial features may be performed on the terminal and the extracted facial features are sent to the server so that the server can compare the received facial features with the predetermined feature template.

According to yet another embodiment, during the process 308, the server sends the comparison result to the terminal. For example, during the process 309, the terminal allows the login request according to predetermined first user information of the first user when the comparison result between the first facial features and the predetermined feature template exceeds a predetermined threshold. In another example, during the process 310, the terminal rejects the login request of the first user when the comparison result between the first facial features and the predetermined feature template does not exceed the predetermined threshold.

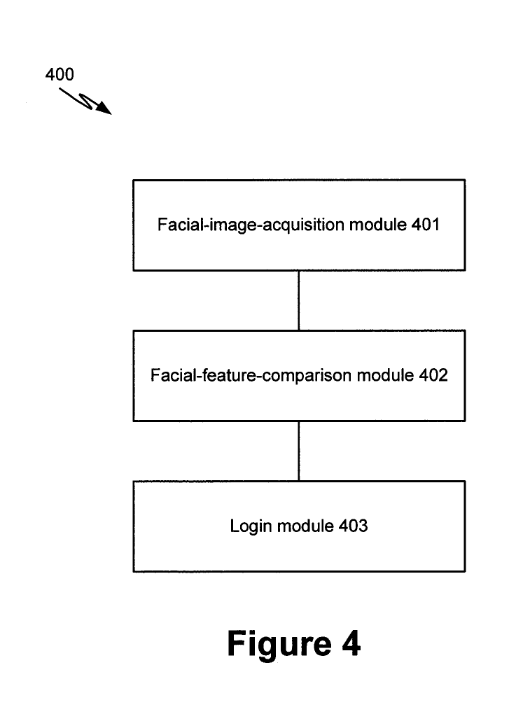

FIG. 4 is a simplified diagram showing a device for user login according to one embodiment of the present invention. This diagram is merely an example, which should not unduly limit the scope of the claims. One of ordinary skill in the art would recognize many variations, alternatives, and modifications. The device 400 includes a facial-image-acquisition module 401, a facial-feature-comparison module 402, and a login module 403.

According to one embodiment, the facial-image-acquisition module 401 is configured to, upon receipt of a login request from a first user, acquire one or more first facial images of the first user, the login request being associated with fast login based on at least information associated with facial authentication. For example, the facial-feature-comparison module 402 is configured to extract one or more first facial features from the one or more first facial images and compare the first facial features with a predetermined feature template. In another example, the login module 403 is configured to, in response to a comparison result associated with the first facial features and the predetermined feature template exceeding a predetermined threshold, allow the first user to log in based on predetermined first user information of the first user.

According to another embodiment, the facial-image-acquisition module 401 is configured to acquire a video clip of the first user and acquire the first facial images from the video clip. For example, the login module 403 is further configured to reject the login request of the first user if the facial-feature-comparison module 402 determines the comparison result between the first facial features and the predetermined feature template does not exceed the predetermined threshold.

According to yet another embodiment, the device 400 further includes a registration module 404 configured to, upon receipt of a registration request for registering facial features, acquire one or more second facial images of a second user, extract one or more second facial features from the second facial images of the second user, generate a predetermined feature template of the second user based on at least information associated with the second facial features, and establish a correspondence between the predetermined feature template of the second user and second user information of the second user.

According to yet another embodiment, the device 400 further includes a cancellation module 405 configured to, upon receipt of a cancellation request, delete the predetermined feature template of the second user and the correspondence between the predetermined feature template of the second user and the second user information of the second user, the cancellation request being associated with cancelling fast login based on at least information associated with facial authentication.

In some embodiments, the device 400 includes any peripheral device capable of image acquisition, such as a cell phone, a tablet, a laptop, a personal computer (PC), a vehicle-mounted electronic system, a personal digital assistant (PDA). For example, the device 400 may be or not be connected to the Internet. In another example, the device 400 may be located at any client capable of image acquisition, such as a PC client software, a mobile client software and a website.

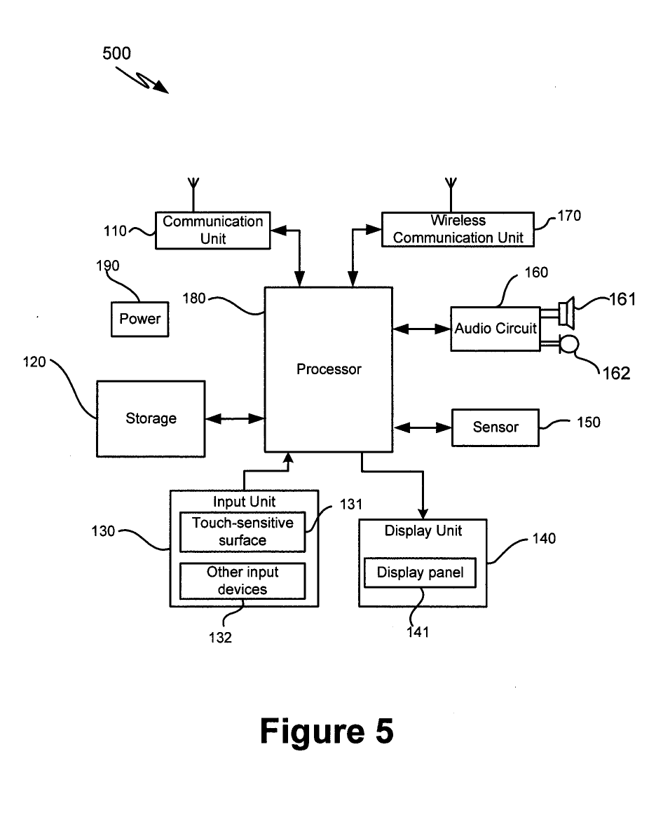

FIG. 5 is a simplified diagram showing a terminal for user login according to one embodiment of the present invention. This diagram is merely an example, which should not unduly limit the scope of the claims. One of ordinary skill in the art would recognize many variations, alternatives, and modifications. The terminal 500 is used to execute a method for user login as described in FIG. 1, FIG. 2 and/or FIG. 3.

According to one embodiment, the terminal 500 includes a communication unit 110, a memory 120 that includes one or more computer-readable storage medium, an input unit 130, a display unit 140, a sensor 150, an audio circuit 160, a wireless (e.g., wireless fidelity) communication unit 170, a processor 180 that includes one or more processing cores, and a power source 190. For example, the communication unit 110 is configured to receive and transmit information or signals during a conversation. As an example, the communication unit 110 includes a radio-frequency (RF) circuit, a router, a MODEM or other network communication equipments. In another example, when including an RF circuit, the communication unit 110 receives downlink data from a base station and delivers the data to one or more processors 180. In yet another example, the communication unit 110 sends uplink data to the base station. For example, the communication unit 110 includes an antenna, one or more amplifiers, a tuner, one or more oscillators, a subscriber ID module (SIM) card, a transceiver, a coupler, an low-noise amplifier (LNA) and/or a duplexer. In another example, the communication unit 110 communicates with the network and other equipments via wireless communication based on any communication standard or protocols, such as GSM (Global System of Mobile communication), GPRS (General Packet Radio Service), CDMA (Code Division Multiple Access), WCDMA (Wideband Code Division Multiple Access), LTE (Long Term Evolution), email and SMS (Short Messaging Service).

According to another embodiment, the memory 120 is configured to store software programs and modules. For example, the processor 180 is configured to execute various functional applications and data processing by running the software programs and modules stored in the memory 120. The memory 120 includes a program storage area and a data storage area, where the program storage area may store the operating system, and the application(s) required by one or more functions (e.g., an audio player or a video player), in some embodiments. For example, the data storage area stores the data created based on the use of the terminal 500 (e.g., audio data or a phone book). In another example, the memory 120 includes a high-speed random access storage, a non-volatile memory, one or more floppy disc storage devices, a flash storage device or other volatile solid storage devices. As an example, the memory 120 further includes a memory controller to enable access to the memory 120 by the processor 180 and the input unit 130.

According to yet another embodiment, the input unit 130 is configured to receive an input number or character data and generate inputs for a keyboard, a mouse, and a joystick, optical or track signals relating to user setting and functional control. For example, the input unit 130 includes a touch-sensitive surface 131 and other input devices 132. The touch-sensitive surface 131 (e.g., a touch screen or a touch panel) is configured to receive the user's touch operations thereon or nearby (e.g., the user's operations on or near the touch-sensitive surface 131 with a finger, a touch pen or any other appropriate object or attachment) and drive the corresponding connected devices according to the predetermined program. For example, the touch-sensitive surface 131 includes two parts, namely a touch detector and a touch controller. The touch detector detects the position of user touch and the signals arising from such touches and sends the signals to the touch controller. The touch controller receives touch data from the touch detector, converts the touch data into the coordinates of the touch point, sends the coordinates to the processor 180 and receives and executes the commands received from the processor 180. For example, the touch-sensitive surface 131 is of a resistance type, a capacitance type, an infrared type and a surface acoustic wave type. In another example, other than the touch-sensitive surface 131, the input unit 130 includes the other input devices 132. For example, the other input devices 132 include one or more physical keyboards, one or more functional keys (e.g., volume control keys or switch keys), a track ball, a mouse and/or a joystick.

According to yet another embodiment, the display unit 140 is configured to display data input from a user or provided to the user, and includes various graphical user interfaces of the terminal 500. For example, these graphical user interfaces include graphs, texts, icons, videos and a combination thereof. The display unit 140 includes a display panel 141 which contains a LCD (liquid crystal display), an OLED (organic light-emitting diode). As an example, the touch-sensitive surface 131 can cover the display panel 141. For example, upon detecting any touch operations thereon or nearby, the touch-sensitive surface 131 sends signals to the processor 180 to determine the type of the touch events and then the processor 180 provides corresponding visual outputs on the display panel 141 according to the type of the touch events. Although the touch-sensitive surface 131 and the display panel 141 are two independent parts for input and output respectively, the touch-sensitive surface 131 and the display panel 141 can be integrated for input and output, in some embodiments.

In one embodiment, the terminal 500 includes a sensor 150 (e.g., an optical sensor, a motion sensor or other sensors). For example, the sensor 150 includes an environment optical sensor and adjusts the brightness of the display panel 141 according to the environmental luminance. In another example, the sensor 150 includes a proximity sensor and turns off or backlights the display panel 141 when the terminal 500 moves close to an ear of a user. In yet another example, the sensor 150 includes a motion sensor (e.g., a gravity acceleration sensor) and detects a magnitude of acceleration in all directions (e.g., three axes). Particularly, the sensor 150 detects a magnitude and a direction of gravity when staying still. In some embodiments, the sensor 150 is used for identifying movements of a cell phone (e.g., a switch of screen direction between horizontal and vertical, related games, and a calibration related to a magnetometer) and features related to vibration identification (e.g., a pedometer or a strike). In certain embodiments, the sensor 150 includes a gyroscope, a barometer, a hygroscope, a thermometer and/or an infrared sensor.

In another embodiment, the audio circuit 160, the speaker 161, and the microphone 162 are configured to provide an audio interface between a user and the terminal 500. For example, the audio circuit 160 is configured to transmit electrical signals converted from certain audio data to the speaker 161 that converts such electrical signals into some output audio signals. In another example, the microphone 162 is configured to convert audio signals into electrical signals which are converted into audio data by the audio circuit 160. The audio data are processed in the processor 180 and received by the communication unit 110 (e.g., a RF circuit) before being sent to another terminal, in some embodiments. For example, the audio data are output to the memory 120 for further processing. As an example, the audio circuit 160 includes an earphone jack for communication between a peripheral earphone and the terminal 500.

For wireless communication, the terminal 500 includes a wireless communication unit 170 which contains a WiFi module, in some embodiments. WiFi is a short-distance wireless transmission technology. Through the wireless communication unit 170, the terminal 500 enables the user to receive and send emails, browse webpages, and/or access stream media. For example, the terminal 500 is configured to provide the user with a wireless broadband Internet access. In some embodiments, the wireless communication unit 170 is omitted in the terminal 500.

According to one embodiment, the processor 180 is the control center of the terminal 500. For example, the processor 180 is connected to various parts of the terminal 500 (e.g., a cell phone) via various interfaces and circuits, and executes various features of the terminal 500 and processes various data through operating or executing the software programs and/or modules stored in the memory 120 and calling the data stored in the memory 120, so as to monitor and control the terminal 500 (e.g., a cell phone). As an example, the processor 180 includes one or more processing cores. In another example, the processor 180 is integrated with an application processor and a modem processor, where the application processor mainly handles the operating system, the user interface and the applications and the modem processor mainly handles wireless communications. In some embodiments, the modem processor is not integrated into the processor 180.

According to another embodiment, the terminal 500 includes the power source 190 (e.g., a battery) that powers up various parts. For example, the power source 190 is logically connected to the processor 180 via a power source management system so that the charging, discharging and power consumption can be managed via the power source management system. In another example, the power source 190 includes one or more DC or AC power sources, a recharging system, a power-failure-detection circuit, a power converter, an inverter, a power source state indicator, or other components.

According to yet another embodiment, the terminal 500 includes a camera, and/or a Bluetooth module. For example, the display unit of the terminal 500 is a touch screen display and the terminal 500 further includes a memory and one or more programs, where the one or more programs are stored in the memory and are configured so that one or more processors execute instructions contained in the one or more programs for certain operations as described in FIG. 1, FIG. 2, and/or FIG. 3.

According to one embodiment, a method is provided for user login. For example, a login request from a first user is received, the login request being associated with fast login based on at least information associated with facial authentication; one or more first facial images of the first user are acquired; one or more first facial features are extracted from the one or more first facial images; the first facial features are compared with a predetermined feature template; and in response to a comparison result associated with the first facial features and the predetermined feature template exceeding a predetermined threshold, the first user is allowed to log in based on predetermined first user information of the first user. For example, the method is implemented according to at least FIG. 1, FIG. 2, and/or FIG. 3.

According to another embodiment, a device for user login includes a facial-image-acquisition module, a facial-feature-comparison module, and a login module. The facial-image-acquisition module is configured to, upon receipt of a login request from a first user, acquire one or more first facial images of the first user, the login request being associated with fast login based on at least information associated with facial authentication. The facial-feature-comparison module is configured to extract one or more first facial features from the one or more first facial images and compare the first facial features with a predetermined feature template. The login module is configured to, in response to a comparison result associated with the first facial features and the predetermined feature template exceeding a predetermined threshold, allow the first user to log in based on predetermined first user information of the first user. For example, the device is implemented according to at least FIG. 4, and/or FIG. 5.

According to yet another embodiment, a system for user login includes one or more data processors, and a computer-readable storage medium encoded with instructions for commanding the data processors to execute certain operations. For example, a login request from a first user is received, the login request being associated with fast login based on at least information associated with facial authentication; one or more first facial images of the first user are acquired; one or more first facial features are extracted from the one or more first facial images; the first facial features are compared with a predetermined feature template; and in response to a comparison result associated with the first facial features and the predetermined feature template exceeding a predetermined threshold, the first user is allowed to log in based on predetermined first user information of the first user. For example, the system is implemented according to at least FIG. 1, FIG. 2, and/or FIG. 3.

According to yet another embodiment, a non-transitory computer readable storage medium comprises programming instructions for user login. The programming instructions are configured to cause one or more data processors to execute certain operations. For example, a login request from a first user is received, the login request being associated with fast login based on at least information associated with facial authentication; one or more first facial images of the first user are acquired; one or more first facial features are extracted from the one or more first facial images; the first facial features are compared with a predetermined feature template; and in response to a comparison result associated with the first facial features and the predetermined feature template exceeding a predetermined threshold, the first user is allowed to log in based on predetermined first user information of the first user. For example, the storage medium is implemented according to at least FIG. 1, FIG. 2, and/or FIG. 3.

The above only describes several scenarios presented by the present disclosure, and the description is relatively specific and detailed, yet it cannot therefore be understood as limiting the scope of this invention's patent. It should be noted that ordinary technicians in the field may also, without deviating from the invention's conceptual premises, make a number of variations and modifications, which are all within the scope of this invention. As a result, in terms of protection, the patent claims shall prevail.

For example, some or all components of various embodiments of the present invention each are, individually and/or in combination with at least another component, implemented using one or more software components, one or more hardware components, and/or one or more combinations of software and hardware components. In another example, some or all components of various embodiments of the present invention each are, individually and/or in combination with at least another component, implemented in one or more circuits, such as one or more analog circuits and/or one or more digital circuits. In yet another example, various embodiments and/or examples of the present invention is combined.

Additionally, the methods and systems described herein is implemented on many different types of processing devices by program code comprising program instructions that are executable by the device processing subsystem. The software program instructions includes source code, object code, machine code, or any other stored data that is operable to cause a processing system to perform the methods and operations described herein. Other implementations may also be used, however, such as firmware or even appropriately designed hardware configured to carry out the methods and systems described herein.

The systems' and methods' data (e.g., associations, mappings, data input, data output, intermediate data results, final data results, etc.) is stored and implemented in one or more different types of computer-implemented data stores, such as different types of storage devices and programming constructs (e.g., RAM, ROM, Flash memory, flat files, databases, programming data structures, programming variables, IF-THEN (or similar type) statement constructs, etc.). It is noted that data structures describe formats for use in organizing and storing data in databases, programs, memory, or other computer-readable media for use by a computer program.

The systems and methods is provided on many different types of computer-readable media including computer storage mechanisms (e.g., CD-ROM, diskette, RAM, flash memory, computer's hard drive, etc.) that contain instructions (e.g., software) for use in execution by a processor to perform the methods' operations and implement the systems described herein.

The computer components, software modules, functions, data stores and data structures described herein is connected directly or indirectly to each other in order to allow the flow of data needed for their operations. It is also noted that a module or processor includes but is not limited to a unit of code that performs a software operation, and is implemented for example as a subroutine unit of code, or as a software function unit of code, or as an object (as in an object-oriented paradigm), or as an applet, or in a computer script language, or as another type of computer code. The software components and/or functionality is located on a single computer or distributed across multiple computers depending upon the situation at hand.

The computing system can include clients and servers. A client and server are generally remote from each other and typically interact through a communication network. The relationship of client and server arises by virtue of computer programs running on the respective computers and having a client-server relationship to each other.

While this specification contains many specifics, these should not be construed as limitations on the scope or of what is claimed, but rather as descriptions of features specific to particular embodiments. Certain features that are described in this specification in the context or separate embodiments can also be implemented in combination in a single embodiment. Conversely, various features that are described in the context of a single embodiment can also be implemented in multiple embodiments separately or in any suitable subcombination. Moreover, although features is described above as acting in certain combinations and even initially claimed as such, one or more features from a claimed combination can in some cases be excised from the combination, and the claimed combination is directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing is advantageous. Moreover, the separation of various system components in the embodiments described above should not be understood as requiring such separation in all embodiments, and it should be understood that the described program components and systems can generally be integrated together in a single software product or packaged into multiple software products.

Although specific embodiments of the present invention have been described, it will be understood by those of skill in the art that there are other embodiments that are equivalent to the described embodiments. Accordingly, it is to be understood that the invention is not to be limited by the specific illustrated embodiments, but only by the scope of the appended claims.

What is claimed is:

1. A method for user login, the method comprising:
receiving a login request from a first user, the login request being associated with fast login based on at least information associated with facial authentication;
acquiring one or more first facial images of the first user;
extracting one or more first facial features from the one or more first facial images;
comparing the first facial features with a predetermined feature template; and
in response to a comparison result associated with the first facial features and the predetermined feature template exceeding a predetermined threshold, allowing the first user to log in based on predetermined first user information of the first user.

2. The method of claim 1 wherein the acquiring one or more first facial images of the first user comprise:
acquiring a video clip of the first user; and
acquiring the one or more first facial images from the video clip.

3. The method of claim 1, further comprising:
rejecting the login request in response to the comparison result associated with the first facial features and the predetermined feature template not exceeding the predetermined threshold.

4. The method of claim 1, further comprising:
receiving a registration request for registering facial features;
acquiring one or more second facial images of a second user;
extracting one or more second facial features from the second facial images of the second user;
generating a predetermined feature template of the second user based on at least information associated with the second facial features; and
establishing a correspondence between the predetermined feature template of the second user and second user information of the second user.

5. The method of claim 4, further comprising:
receiving a cancellation request for cancelling fast login based on at least information associated with facial authentication; and
deleting the predetermined feature template of the second user and the correspondence between the predetermined feature template of the second user and the second user information of the second user.

6. A device for user login, comprising:
a facial-image-acquisition module configured to, upon receipt of a login request from a first user, acquire one or more first facial images of the first user, the login request being associated with fast login based on at least information associated with facial authentication;
a facial-feature-comparison module configured to extract one or more first facial features from the one or more first facial images and compare the first facial features with a predetermined feature template; and
a login module configured to, in response to a comparison result associated with the first facial features and the predetermined feature template exceeding a predetermined threshold, allow the first user to log in based on predetermined first user information of the first user.

7. The device of claim 6, wherein the facial-image-acquisition module is further configured to acquire a video clip of the first user and acquire the one or more first facial images from the video clip.

8. The device of claim 6, wherein the login module is further configured to reject the login request in response to the comparison result associated with the first facial features and the predetermined feature template not exceeding the predetermined threshold.

9. The device of claim 6, further comprising:
a registration module configured to, upon receipt of a registration request for registering facial features, acquire one or more second facial images of a second user, extract one or more second facial features from the second facial images of the second user, generate a predetermined feature template of the second user based on at least information associated with the second facial features, and establish a correspondence between the predetermined feature template of the second user and second user information of the second user.

10. The device of claim 9, further comprising:
a cancellation module configured to, upon receipt of a cancellation request, delete the predetermined feature template of the second user and the correspondence between the predetermined feature template of the second user and the second user information of the second user, the cancellation request being associated with cancelling fast login based on at least information associated with facial authentication.

11. The device of claim 6, further comprising:
one or more data processors; and
a computer-readable storage medium;
wherein one or more of the facial-image-acquisition module, the facial-feature-comparison module, and the login module are stored in the storage medium and configured to be executed by the one or more data processors.

12. A system for user login, the system comprising:
one or more data processors; and
a computer-readable storage medium encoded with instructions for commanding the data processors to execute operations comprising:
receiving a login request from a first user, the login request being associated with fast login based on at least information associated with facial authentication;
acquiring one or more first facial images of the first user;
extracting one or more first facial features from the one or more first facial images;
comparing the first facial features with a predetermined feature template; and
in response to a comparison result associated with the first facial features and the predetermined feature template exceeding a predetermined threshold, allowing the first user to log in based on predetermined first user information of the first user.

13. A non-transitory computer readable storage medium comprising programming instructions for user login, the programming instructions configured to cause one or more data processors to execute operations comprising:
receiving a login request from a first user, the login request being associated with fast login based on at least information associated with facial authentication;
acquiring one or more first facial images of the first user;
extracting one or more first facial features from the one or more first facial images;
comparing the first facial features with a predetermined feature template; and
in response to a comparison result associated with the first facial features and the predetermined feature template exceeding a predetermined threshold, allowing the first user to log in based on predetermined first user information of the first user.
